(19) United States
(12) Patent Application Publication
(10) Pub. No.: US 2016/0129943 A1
(43) Pub. Date: May 12, 2016

(54) VEHICLE PANEL STRUCTURE, ROOF PANEL AND VEHICLE BODY

(71) Applicant: TOYOTA JIDOSHA KABUSHIKI KAISHA, Toyota-shi, Aichi-ken (JP)

(72) Inventor: Takao TSUKIMORI, Toyota-shi, Aichi-ken (JP)

(73) Assignee: TOYOTA JIDOSHA KABUSHIKI KAISHA, Toyota-shi, Aichi-ken (JP)

(21) Appl. No.: 14/894,208

(22) PCT Filed: May 28, 2014
(86) PCT No.: PCT/IB2014/000881

§ 371 Date: Nov. 25, 2015

(30) Foreign Application Priority Data
May 31, 2013 (JP) 2013-115237

(51) Int. Cl. B62D 25/00; B62D 25/02; B62D 25/06; B62D 29/00

(52) U.S. Cl. CPC B62D 25/00; B62D 29/00; B62D 25/02; B62D 25/06

(57) ABSTRACT

A vehicle panel structure includes: a vehicle outer plate panel having a reinforcement installation region on a vehicle inner side surface; a reinforcement provided in the installation region; and a connecting member placed between the installation region and the reinforcement. The connecting member is made from a connecting material having a loss factor tan δ of not less than 0.6.

### BACKGROUND OF THE INVENTION

1. Field of the Invention

The present invention relates to a vehicle panel structure, a roof panel and a vehicle body.

2. Description of Related Art

Japanese Patent Application Publication No. 2010-083248 (JP 2010-083248 A) describes a vehicle panel structure in which a roof reinforcement (reinforcement) is deformed to push a mastic sealer (mastic) against a roof panel (outer plate panel).

Such a technique gives a biasing force to the roof reinforcement in advance. Accordingly, even if the roof panel thermally expands, the roof reinforcement continues pushing the mastic sealer against the roof panel due to its own deformation.

A mastic or a filler mainly made from rubber is filled between the reinforcement and the outer plate panel such as a roof. The mastic is provided between the roof panel and the reinforcement so as to transmit a force of the reinforcement to restrict a shape. This allows the roof panel to obtain a dent resistance characteristic.

### SUMMARY OF THE INVENTION

The vehicle panel structure is excellent in restraining an “occurrence” of vibration, noise, and the like. However, the vehicle panel structure is not suitable for reducing its own vibration that has once occurred. The present invention provides a vehicle panel structure, a roof panel and a vehicle body each of which promptly “reduces” a vibration that has once occurred. Further, the present invention provides a vehicle panel structure, a roof panel and a vehicle body each of which achieves noise reduction by reduction of vibration.

A first aspect of the present invention relates to a vehicle panel structure. The vehicle panel structure includes: a vehicle outer plate panel having a reinforcement installation region on a vehicle inner side surface; a reinforcement provided in the installation region; and a connecting member placed between the installation region and the reinforcement. The connecting member is made from a connecting material having a loss factor tan δ of not less than 0.6.

The reinforcement may make contact with the connecting member. The reinforcement may make contact with the connecting member via a connecting surface placed in an outer edge of the reinforcement and facing an outer-plate-panel side. The connecting member may be placed only between the installation region and the connecting surface.

The connecting member may form a linear shape along a skeletal center of the reinforcement. The connecting member may form a dispersed shape continued at predetermined intervals along a skeletal center of the reinforcement.

The reinforcement may further include a recessed portion placed in the skeletal center of the reinforcement and having an opening on the outer-plate-panel side. The installation region may make contact with the opening.

The connecting member may make contact with the installation region. The connecting material may have a loss factor tan δ of not less than 0.9. The connecting material may be butyl rubber or rubber-modified asphalt.

The vehicle panel structure may further include a damp sheet made from a sheet material having a loss factor tan δ of not less than 0.25. The outer plate panel may have a reinforcement non-installation region on the vehicle inner side. The damp sheet may be connected to the non-installation region.

The damp sheet may be connected to a predetermined range of the non-installation region, and the predetermined range may occupy 25% or less of an area of the non-installation region. The sheet material may have a loss factor tan δ of not more than 0.6.

The outer plate panel may have a reinforcement non-installation region on the vehicle inner side. The non-installation region may not be connected to a damp sheet made from a sheet material having a loss factor tan δ of not less than 0.6. The non-installation region may not be connected to a damp sheet made from a sheet material having a loss factor tan δ of not less than 0.25.

The outer plate panel may have a reinforcement non-installation region on the vehicle inner side. A predetermined range in the non-installation region may make contact with a space on the vehicle inner side. The predetermined range may occupy 75% or more of an area of the non-installation region. The outer plate panel may have a reinforcement non-installation region on the vehicle inner side. The non-installation region may make contact with only a space on the vehicle inner side.

A second aspect of the present invention relates to a roof panel. In the roof panel, a plurality of reinforcements according to the first aspect is arranged in line at predetermined intervals, and the non-installation region is surrounded by the installation region, front and rear headers, and installing parts to side roof rails.

A third aspect of the present invention relates to a vehicle panel structure. The vehicle panel structure includes a vehicle outer plate panel having an installation region for an inner plate panel on a vehicle inner side surface. The vehicle panel structure further includes the inner plate panel provided in the installation region. The vehicle panel structure includes a connecting member placed between the installation region and the inner plate panel. The connecting member is made from a connecting material having a loss factor tan δ of not less than 0.6.

A fourth aspect of the present invention relates to a vehicle body. The vehicle body includes an outer plate panel for a roof panel, the outer plate panel having an installation region for a front or rear header on a vehicle inner side surface. The vehicle body includes the header connected to the installation region. The vehicle body includes a connecting member placed between the installation region and the header. The connecting member is made from a connecting material having a loss factor tan δ of not less than 0.6.

The vehicle panel structure, the roof panel and the vehicle body according to the first to fourth aspects of the present invention is able to promptly reduce a vibration that has once occurred. Further, the vehicle panel structure is able to achieve noise reduction by reducing the vibration.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view of a vehicle panel structure according to an embodiment of the present invention;

FIG. 2 is a schematic view illustrating a molecular structure of a connecting material;

FIG. 3 is a sectional view of a vehicle panel structures according to Comparative Examples 1 to 3;

FIG. 4 is a graph 1 illustrating changes of amplitude of the vehicle panel structure according to Comparative Example 1;

FIG. 5 is a graph illustrating respective vibration control efficiencies of the vehicle panel structures according to respective Comparative Examples;

FIG. 6 is a graph 2 illustrating changes of amplitude of the vehicle panel structure according to Comparative Example 1;

FIG. 7 is a graph illustrating changes of amplitude of the vehicle panel structure according to Comparative Example 2;

FIG. 8 is a graph illustrating changes of amplitude of the vehicle panel structure according to Comparative Example 3;

FIG. 9 is a graph illustrating respective vibration control efficiencies of vehicle panel structures according to Examples of the present invention;

FIG. 10 is a graph illustrating changes of amplitude of the vehicle panel structure according to Example 1 of the present invention;

FIG. 11 is a graph illustrating changes of amplitude of the vehicle panel structure according to Example 2 of the present invention;

FIG. 12 is a graph illustrating a relationship between a loss factor and noise caused by the vehicle panel structure;

FIG. 13 is a graph illustrating a relationship between a loss factor and a vibration of the vehicle panel structure;

FIG. 14 is a graph illustrating respective used amounts of butyl rubber in Example 1 of the present invention and Comparative Example 2;

FIG. 15 is an external view of a roof panel according to Example 4 of the present invention;

FIG. 16 is a sectional view of the roof panel according to Example 4 of the present invention;

FIG. 17 is a partial enlarged view of a section of the roof panel according to Example 4 of the present invention;

FIG. 18 is a configuration diagram of a door panel according to Example 5 of the present invention;

FIG. 19 is a sectional view of a vehicle panel structure according to Example 6 of the present invention; and

FIG. 20 is a sectional view of a vehicle panel structure according to Example 7 of the present invention.

### DETAILED DESCRIPTION OF EMBODIMENTS

### Summary

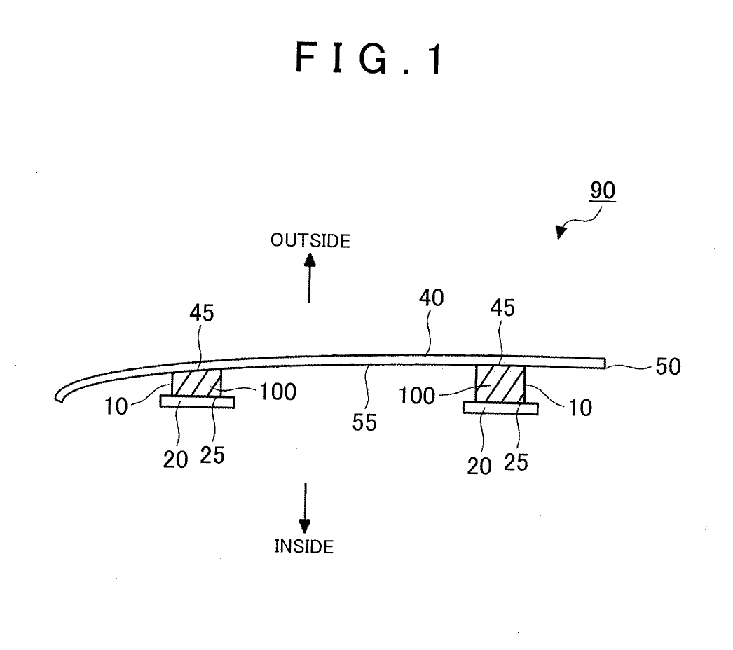

As illustrated in FIG. 1, a vehicle panel structure 90 of the present embodiment includes an outer plate panel 40 and a reinforcement 20. The outer plate panel 40 is an outer panel for a vehicle. The outer plate panel 40 has an installation region 45 for the reinforcement 20. The installation region 45 is placed on an inner surface 50 facing a vehicle inner side of the outer plate panel 40.

The reinforcement 20 is provided in the installation region 45. The reinforcement 20 may be formed by plastically deforming one plate, or one reinforcement may be formed by combining a plurality of members.

The vehicle panel structure 90 further includes a connecting member 10. The connecting member 10 is placed between the installation region 45 and the reinforcement 20. The connecting member 10 is made from a connecting material 100 having a predetermined loss factor tan δ.

The loss factor tan δ is preferably larger than 0.25, further preferably 0.6 or more, and particularly preferably 0.9 or more. It is preferable that the connecting material 100 be butyl rubber or rubber-modified asphalt.

The vehicle panel structure 90 is able to promptly reduce a vibration caused in the outer plate panel 40. Further, the vehicle panel structure 90 immediately reduces sound caused due to the vibration of the outer plate panel 40. This allows the vehicle panel structure 90 to achieve noise reduction in a direction of the vehicle inner side and a direction of a vehicle outer side.

### [Vehicle Panel Structure]

Concrete examples of the vehicle panel structure are a roof panel and a door panel for a side door or a back door. When these panels have the aforementioned structure, it is possible to reduce noise of a vehicle interior in particular. The vehicle panel structure is not limited to them, but also useful for a hood panel, a back panel, a trunk lid, a fender panel, a side panel, an under cover, and the like.

### [Connecting Member]

In the vehicle panel structure 90, the connecting member 10 and the reinforcement 20 constitutes a restriction-type vibration control structure. In order for the reinforcement 20 to function as a constraint layer efficiently, it is preferable that the reinforcement 20 make contact with the connecting member 10.

Such a structure causes the following excellent effects. First, a vibration control performance of the vehicle panel structure 90 further increases. Further, the reinforcement 20 makes close contact with the outer plate panel 40 so as to restrain its deformation. That is, the reinforcement 20 increases a dent resistance characteristic of the vehicle panel structure 90.

The reinforcement 20 makes contact with the connecting member 10 via a connecting surface 25 of the reinforcement 20. The connecting surface 25 faces an outer-plate-panel-40 side, that is, the direction of the vehicle outer side. This further increases the effect to be given to the vehicle panel structure 90. The connecting member 10 makes contact with the installation region 45. Such a structure further increases the effect to be given to the vehicle panel structure 90.

The connecting member 10 is placed only between the installation region 45 and the connecting surface 25. Such a structure is able to reduce an amount of the connecting material 100 without decreasing each of the above effects. This makes it possible to reduce an economical cost and an environment load for manufacture of the vehicle panel structure 90.

### [Connecting Material]

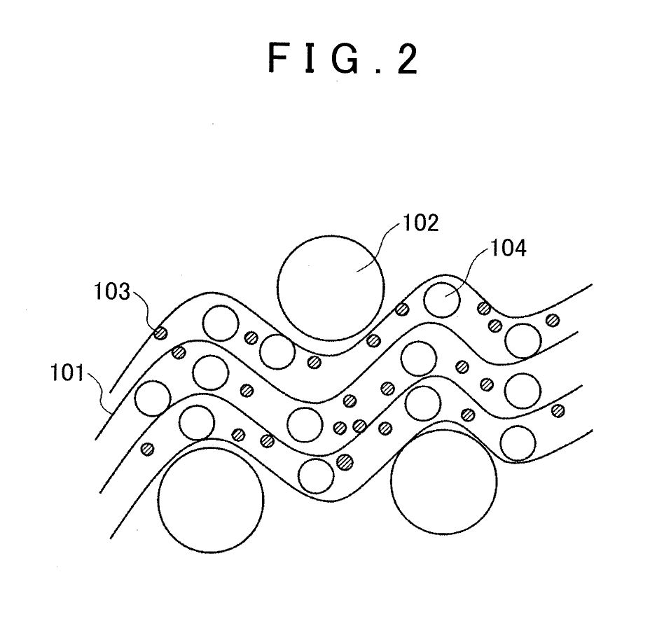

As illustrated in FIG. 2, it is preferable that the connecting material 100 contain a base compound 101, an extender 102, a tackifier 103, and a plasticizer 104.

The base compound is preferably a rubber based material, and further preferably a chain polymer. The polymer preferably has a polymerization degree higher than that of mastic rubber such as butadiene rubber. The polymer is preferably a copolymer (butyl rubber) represented by the following formula (1). In the present specification, the connecting material 100 itself which contains such a copolymer may be referred to as butyl rubber.

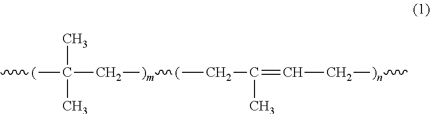

In the copolymer represented by the above formula (1), m indicates a monomer ratio of isobutene and n indicates a monomer ratio of the isoprene.

The extender 102 may be an organic or inorganic material, and is preferably calcium carbonate (CaCO₃) from a viewpoint of stability to an organic solvent. The extender 102 increases a volume of the connecting material 100.

The tackifier 103 is preferably a low-molecular organic component. Such an organic component gives an adhesive property to the connecting material 100. Due to an action of the tackifier 103, the connecting material 100 adheres to the installation region 45 or the connecting surface 25.

The plasticizer is preferably a plasticizer that weakens a bonding strength between molecules of the base compound. A material of the plasticizer is not limited in particular. However, from a viewpoint of adjusting flexibility and fluidity of the connecting material 100, the material is preferably diisononyl phthalate (DINP, C₂₆H₄₂O₄) represented by the following formula (2).

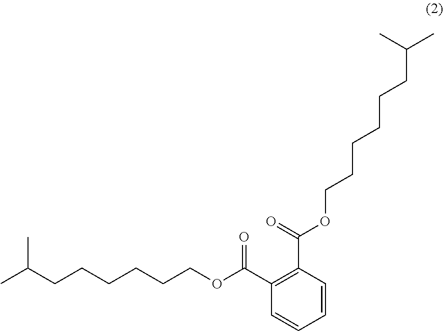 [SMILES: CC(C)CCCCCCOC(=O)c1ccccc1C(=O)OCCCCCCC(C)C]

As illustrated in FIG. 2, in the connecting material 100, the plasticizer 104 exists between principal chains of the base compound 101. The plasticizer 104 increases a distance between those molecules of the base compound 101 which are chain molecules, so as to weaken an attracting force therebetween, thereby causing the base compound 101 to have a flexible property. The tackifier 103 having a polarity disperses between those molecules of the base compound 101 which are thus distanced. Further, the extender 102 disperses entirely in the connecting material 100.

The connecting material 100 has the following vibration control performance. Different from a rubber of mastic or the like, the base compound 101 does not have cross links, or has cross links only at a ratio less than that of the mastic. Accordingly, the base compound 101 has a viscosity property at a room temperature. Further, the connecting material 100 may not have properties for maintaining its structure, and may be gel having fluidity.

When the base compound 101 moves at a high speed, a resistance occurs due to friction between the molecules. The resistance converts a kinetic energy into a thermal energy. Hereby, a vibration of the outer plate panel 40 is damped by the connecting material 100, and reduced promptly.

Further, the connecting material 100 may be rubber-modified asphalt. One aspect of the rubber-modified asphalt is obtained by combining crude rubber with asphalt. Examples of the crude rubber are natural rubber, styrene butadiene rubber, chloroprene rubber, and styrene-butadiene-styrene block copolymer (SBS).

### [Description of Effects: Related Art]

Effects yielded by the vehicle panel structure 90 of the present embodiment will be described below in consideration of the vehicle panel structure described in Background Art. The following assumes that the mastic is used instead of the connecting material 100 of the connecting member 10 in FIG. 1.

A general mastic is an elastic adhesive based on synthetic rubber. The mastic adheres an outer plate panel (outer panel) to a roof reinforcement or an inner plate panel (inner panel). The mastic increases a rigidity of the vehicle panel structure and restrains an occurrence of vibration and noise in the outer plate panel.

A main component of the mastic is rubber having cross links sufficiently enough to maintain a structure synthesis. Accordingly, since the mastic has a low loss factor, its vibration control performance is also low. Because of this, in the vehicle panel structure having the mastic, it is difficult to reduce a vibration of the outer plate panel. A force of the mastic to damp a vibration of a roof during running or an impact/vibration at the time when a door, a hood, or the like is closed vigorously. Accordingly, the vehicle panel structure generates noise.

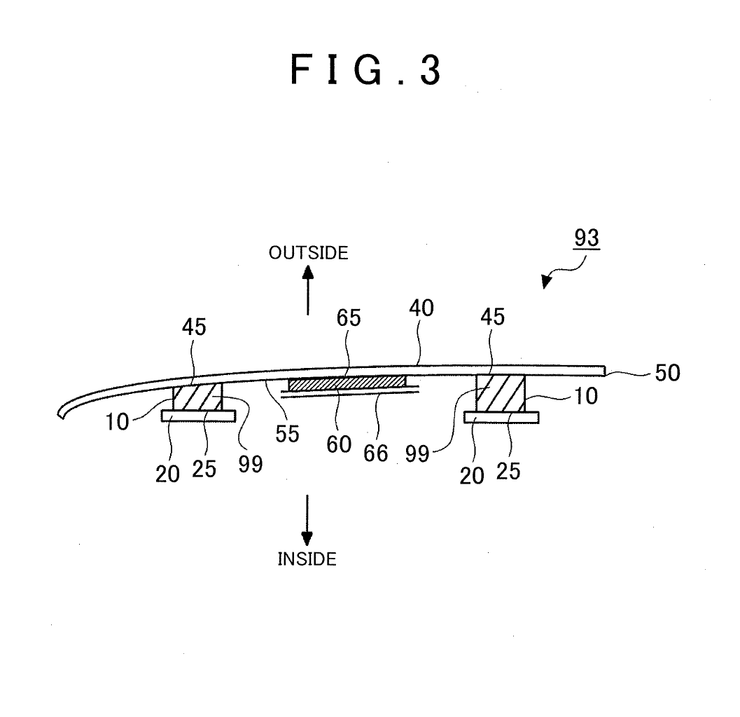

In the vehicle panel structure having the mastic, there is such a case where other members for a vibration control should be added. For example, as illustrated in FIG. 3, a roof panel 93, which is one aspect of the vehicle panel structure, includes a damp sheet 60 placed between reinforcements 20 adjacent to each other. In FIG. 3, a connecting member 10 is made from a mastic 99. However, the damp sheet 60 brings only a restrictive effect about vibration control and noise reduction.

### [Description of Effects: Connecting Material]

On the other hand, in the present embodiment, the vehicle panel structure 90 has the connecting material 100 exhibiting a high loss factor, such as butyl rubber. The connecting material 100 is placed in a part to which the mastic is applied in a case of the related art. Such a configuration reduces amplitude of the outer plate panel 40 immediately. Further, a time required for a reduction of a vibration thereof is shortened.

On that account, even if there is no damp sheet 60 as illustrated in FIG. 1, the vehicle panel structure 90 is able to promptly reduce a vibration of the outer plate panel 40 during running and a vibration due to an impact added to the outer plate panel 40 at the time when a door is closed vigorously. The vehicle panel structure 90 is able to reduce noise from such a vibration or sound of door closing.

As further described later, inventors found not only a fact that the vehicle panel structure of the present embodiment does not need a damp sheet, but also a fact that the vehicle panel structure of the present embodiment yields, a vibration control effect excellent than a vehicle panel structure having a damp sheet.

### [Description of Effects: Installation Region]

The installation region 45 corresponds to that part in the related art at which the outer plate panel 40 is connected to the reinforcement 20 by the mastic. The installation region 45 corresponds to a node of a vibration of the outer plate panel 40.

In the present embodiment, the connecting member 10 made from the connecting material 100 having a high loss factor is placed in such a node portion. On the other hand, in the related art, a damp sheet having a high loss factor is placed in a part corresponding to an antinode of the vibration.

The inventors found that a case where a material exhibiting a high loss factor is used for the part corresponding to the node of the vibration yields a high vibration control effect and a high noise reduction effect, in comparison with a case where a material having a high loss factor is affixed to the part corresponding to the antinode of the vibration.

### [Reinforcement Non-Installation Region]

Since the installation region 45 is provided, the vehicle panel structure 90 of the present embodiment yields the excellent effects as described above. The following describes a preferable aspect of a region other than the installation region 45 in the outer plate panel 40.

As illustrated in FIG. 1, the outer plate panel 40 has a non-installation region 55 not provided with the reinforcement 20, on the vehicle inner side. The non-installation region 55 may not be connected to a damp sheet. Here, the damp sheet assumed herein is made from a sheet material having a loss factor tan δ of not less than 0.6, or not less than 0.25.

A predetermined range in the non-installation region 55 may make contact with a space on the vehicle inner side. The predetermined range preferably occupies at least 75% of an area of the non-installation region 55. The non-installation region 55 may make contact with only the space on the vehicle inner side.

### [Description of Effects: Non-Installation Region and Damp Sheet]

In a case where the non-installation region 55 illustrated in FIG. 3 has a shape that is not planar, such as an uneven surface or a curved surface, even if the damp sheet is connected to this, its followability is poor. This is because the damp sheet is connected to a solid and monotonous constraint layer. Accordingly, a gap is formed between the damp sheet 60 and the outer plate panel 40.

The gap becomes a part where water is accumulated, which may cause rust/corrosion in the outer plate panel 40. Further, the gap may induce peeling or distortion of the damp sheet 60 itself. On this account, the damp sheet is unsuitable for the outer plate panel having a complicated surface.

On the other hand, in FIG. 1, it is possible to perform plastic deformation machining on the reinforcement 20 before the reinforcement 20 is attached to the outer plate panel 40. Accordingly, it is possible to shape the reinforcement 20 in a relatively free manner. Further, the non-installation region 55 may make contact with the space as described above. In view of this, the vehicle panel structure 90 is able to yield the aforementioned vibration control/noise reduction effects without being influenced by the shape of the outer plate panel 40.

In a case where the non-installation region 55 includes a shape that is not planar, affixing of the damp sheet is easy to become poor. Further, the outer plate panel may be distorted at an affixing part to which the damp sheet is affixed. Further, the outer plate panel may corrode in a surface boundary between the damp sheet and the outer plate panel.

A formation of the damp sheet requires molding of butyl rubber into a sheet-like shape, attaching of a constraint, layer to the damp sheet, and affixing of the damp sheet to the outer plate panel. Such steps become a factor of an increase of a manufacturing cost. In view of this, although the damp sheet brings a high effect, it is necessary to carefully design a vehicle panel structure having a damp sheet.

On the other hand, in the vehicle panel structure 90 of the present embodiment, instead of a step of applying a mastic to the reinforcement 20, only a step of attaching the connecting member 10 is just added. That is, it is not necessary to attach the reinforcement 20 and the damp sheet 60 separately as in FIG. 3, and it is only necessary to attach the reinforcement 20 by use of the connecting member 10.

In the related art, the damp sheet is affixed to that region in the non-installation region 55 which has an area ratio of 50% or less. The vehicle panel structure 90 has the connecting material 100 having the aforementioned loss characteristic. In view of this, without using the damp sheet, it is possible to obtain a vibration control performance equivalent to that of the vehicle panel structure having the damp sheet, as described later.

### EXAMPLES

In a description of each example, the same constituent as a constituent in the above embodiment or an example mentioned earlier has the same reference sign as the constituent in the above embodiment or the example mentioned earlier, and a redundant description thereof is omitted.

### Example 1

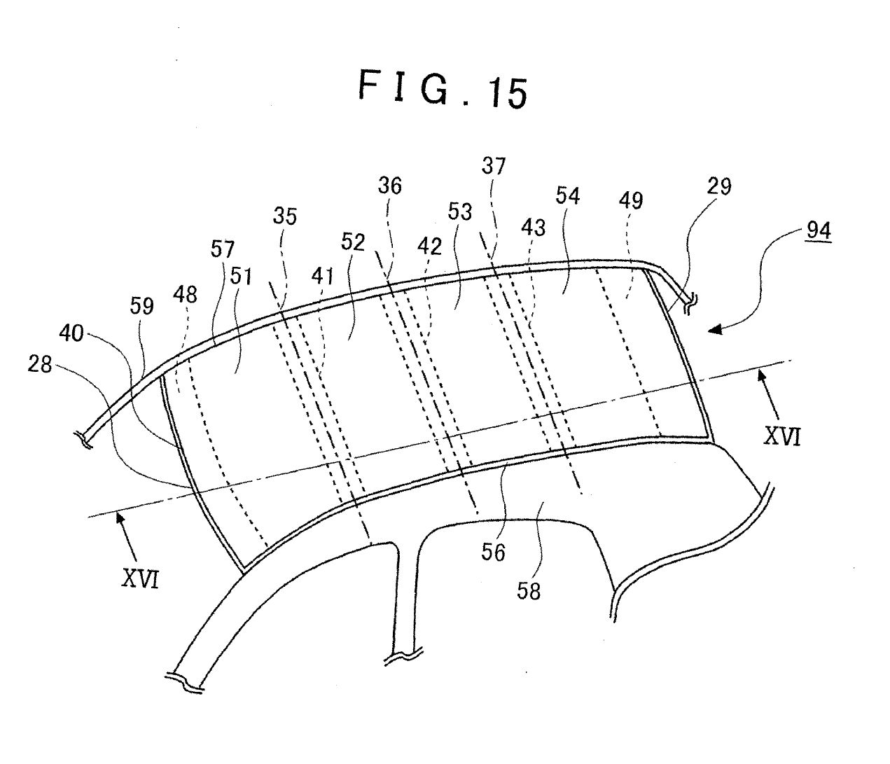

A vehicle panel structure of the present example is a roof panel having the vehicle panel structure 90 illustrated in FIG. 1. The roof panel corresponds to a roof panel 94 illustrated in FIG. 15 to be described later. A connecting material 100 is XETORO α (tan δ=0.6), which is butyl rubber made by IIDA INDUSTRY CO., LTD. The connecting material 100 may be XETORO β or γ made by the same company.

In the present embodiment, the loss factor tan δ indicates a ratio (E″/E′) between a loss elastic modulus E″ (Pa) of a component spreading outside the material as heat and a storage elastic modulus E′ (Pa) of a component stored inside the material, in energy caused due to a stress given to the material.

### Example 2

A vehicle panel structure of the present example is a roof panel different from Example 1 only in the connecting material 100. The connecting material 100 is a heat dissipation elastomer CH (tan δ=0.9), which is a rubber asphalt sheet made by ARONKASEI CO., LTD. The other constituents are the same as in Example 1.

### Comparative Example 1

As illustrated in FIG. 3, a roof panel 93 of the present comparative example includes an outer plate panel 40 and a reinforcement 20. The outer plate panel 40 has an installation region 45 for the reinforcement 20. The installation region 45 is placed on an inner surface 50 facing a vehicle inner side of the outer plate panel 40. The reinforcement 20 is provided in the installation region 45.

The vehicle panel structure 90 further includes a connecting member 10. The connecting, member 10 is placed between the installation region 45 and the reinforcement 20. The connecting member 10 is made from S440, which is a mastic made by CEMEDINE AUTOMOTIVE CO., LTD.

The outer plate panel 40 has a non-installation region 55 not provided with the reinforcement 20, on the vehicle inner side. The non-installation region 55 is placed between the installation regions 45 adjacent to each other. The roof panel 93 includes a damp sheet 60 placed between the reinforcements 20 adjacent to each other. The damp sheet 60 is connected to the non-installation region 55.

The damp sheet 60 is connected to a whole of the non-installation region 55. The damp sheet 60 is made from a predetermined sheet material. The sheet material is the same material as the connecting material 100 of Example 1. A constraint layer 66 is placed on a vehicle inner side of the damp sheet 60. A material of the constraint layer 66 is an aluminum foil.

### Comparative Example 2

Different from Comparative Example 1, a damp sheet 60 is connected to an affix range 65 in a non-installation region 55. The affix range 65 occupies 50% of an area of the non-installation region 55. The other constituents are the same as in Comparative Example 1.

### Comparative Example 3

Different from Comparative Example 2, an affix range 65 occupies 25% of an area of a non-installation region 55. The other constituents are the same as in Comparative Examples 1, 2.

### Comparative Example 4

Different from Comparative Examples 1 to 3, a roof panel 93 does not include a damp sheet 60. From other viewpoints, a vehicle panel structure of the present comparative example is a roof panel different from Example 1 only in the connecting member 10 illustrated in FIG. 1. The connecting member 10 is made from S440, which is a mastic made by CEMEDINE AUTOMOTIVE CO., LTD.

### [Vibration Control Effect of Damp Sheet]

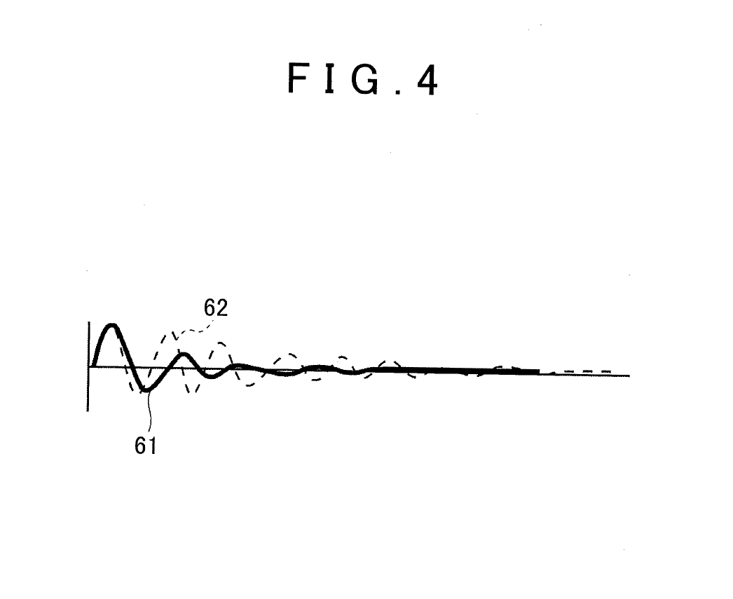

In the graph of FIG. 4, a continuous line 61 is a vibratory curve derived from a computation model of a vibration of the roof panel of Comparative Example 1. A broken line 62 is a vibratory curve derived from a computation model of a vibration of the roof panel of Comparative Example 4. The vibration of the roof panel 93 is damped immediately by the affixing of the damp sheet 60. That is, the damp sheet 60 has a vibration control effect.

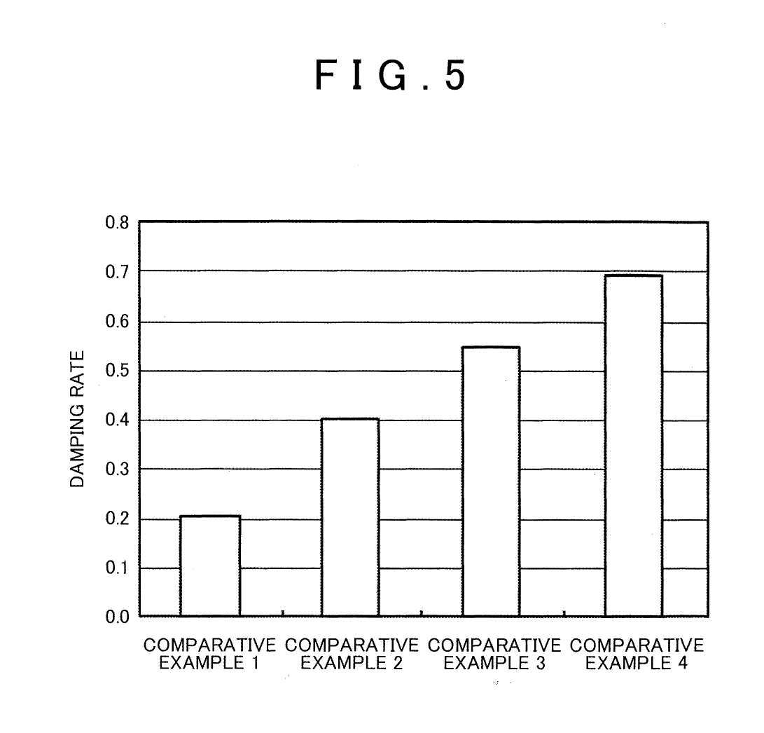

FIG. 5 illustrates a ratio between an amplitude of the third cycle and an amplitude of the first cycle as a damping rate of a vibration of the roof panel in each of the vibratory curves in FIG. 4. Hereinafter, this value is referred to as the damping rate. FIG. 5 also indicates damping rates of Comparative Examples 2, 3.

In the roof panel including only the mastic like Comparative Example 4, the damping rate is approximately 0.7. As an area of the damp sheet included in the roof panel is larger, its vibration damping efficiency increases, so that the vibration is damped faster.

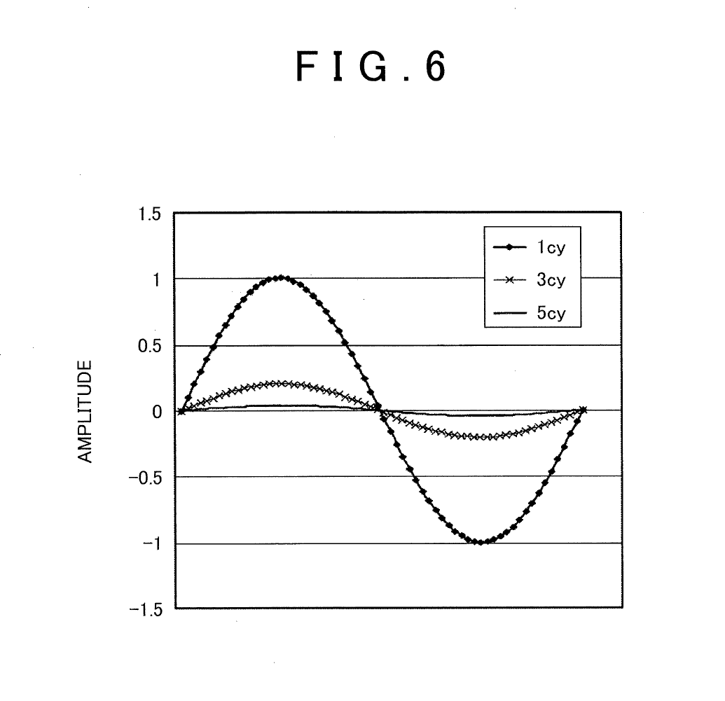

As illustrated in FIG. 5, the damping rate is approximately 0.2 in Comparative Example 1. Note that, as illustrated in FIG. 6, in a case where an amplitude of the first cycle is assumed 1, the amplitude decreases to approximately 0.2 in the third cycle, and to 0.1 or less in the fifth cycle.

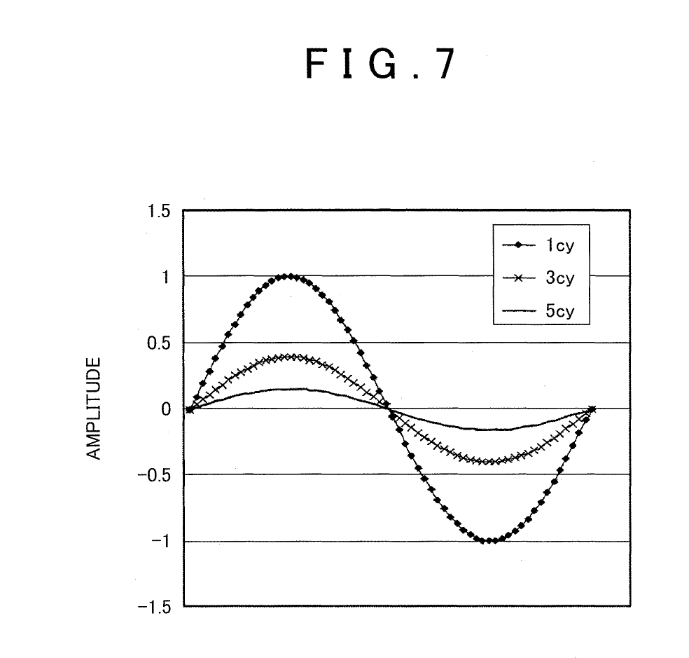

As illustrated in FIG. 5, the damping rate is approximately 0.4 in Comparative Example 2. Note that, as illustrated in FIG. 7, in a case where the amplitude of the first cycle is assumed 1, the amplitude decreases to approximately 0.4 in the third cycle, and to 0.2 or less in the fifth cycle.

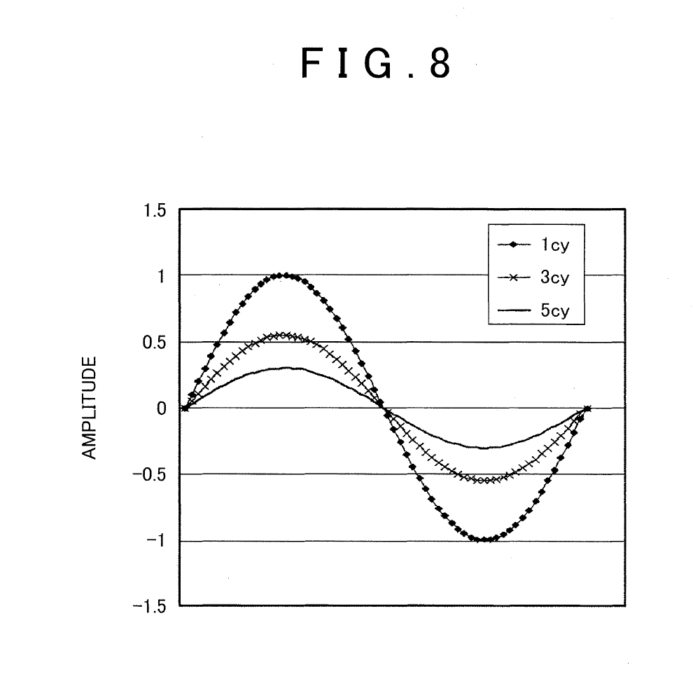

As illustrated in FIG. 5, the damping rate is approximately 0.5 to 0.6 in Comparative Example 3. Note that, as illustrated in FIG. 8, in a case where the amplitude of the first cycle is assumed 1, the amplitude decreases to 0.6 or less in the third cycle, and to approximately 0.3 in the fifth cycle.

### [Vibration Control Effect of Connecting Material]

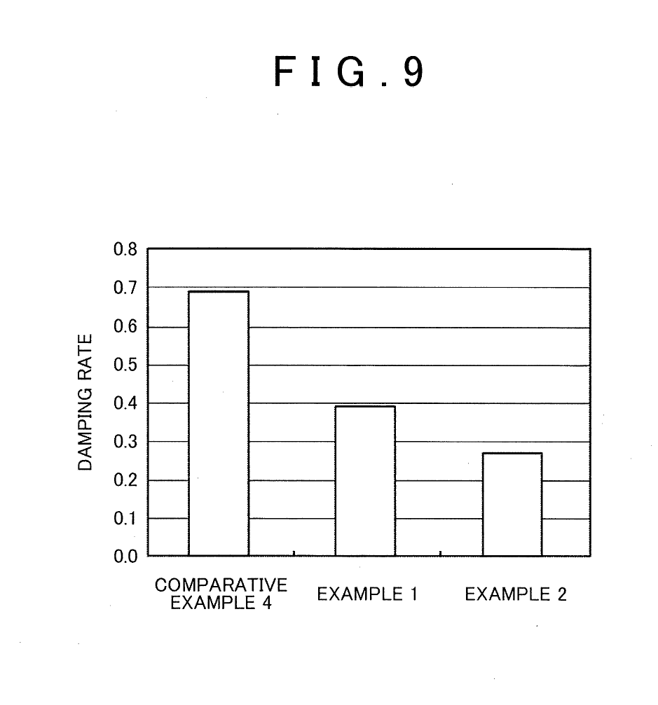

FIG. 9 is a graph illustrating damping rates obtained by a computation model similar to the above, in terms of Examples 1, 2, and Comparative Example 4.

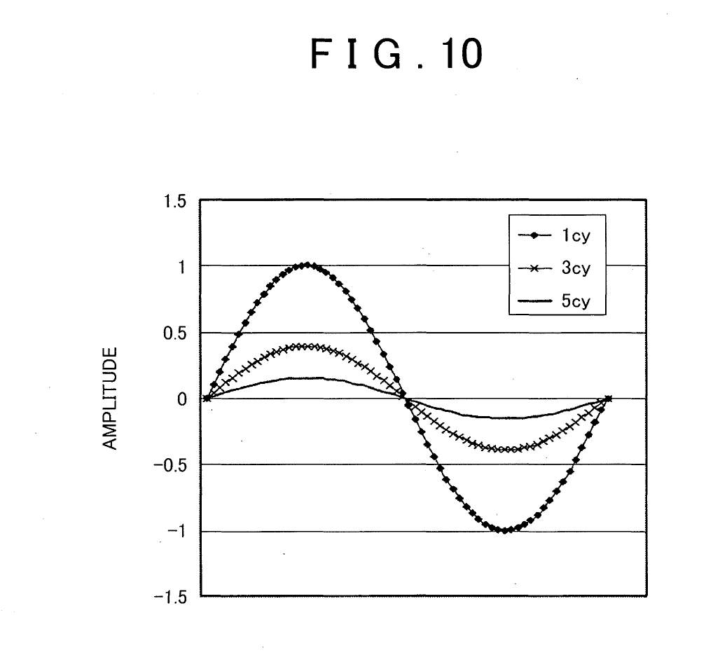

As illustrated in FIG. 9, the damping rate is approximately 0.4 in Example 1. Note that, as illustrated in FIG. 10, in a case where the amplitude of the first cycle is assumed 1, the amplitude decreases to approximately 0.4 in the third cycle, and to 0.2 or less in the fifth cycle.

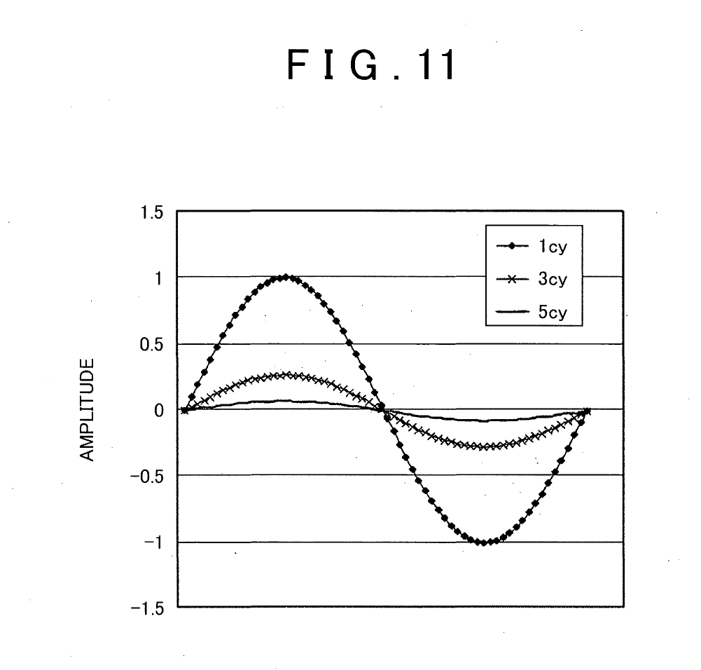

As illustrated in FIG. 9, the damping rate is approximately 0.3 or less in Example 2. Note that, as illustrated in FIG. 11, in a case where the amplitude of the first cycle is assumed 1, the amplitude decreases to approximately 0.3 in the third cycle, and to 0.1 or less in the fifth cycle.

The above analysis results shows that, when a high-damping material is applied to an application part for the mastic as in Comparative Example 4, for example, it is possible to obtain a vibration damping efficiency equivalent to or higher than a case where a damp sheet is affixed. In Example 1, the damping efficiency is equivalent to the damping efficiency in Comparative Example 2. Further, in Example 2, the damping efficiency is close to the damping efficiency in Comparative Example 1.

### [Noise Reduction Effect of Connecting Material]

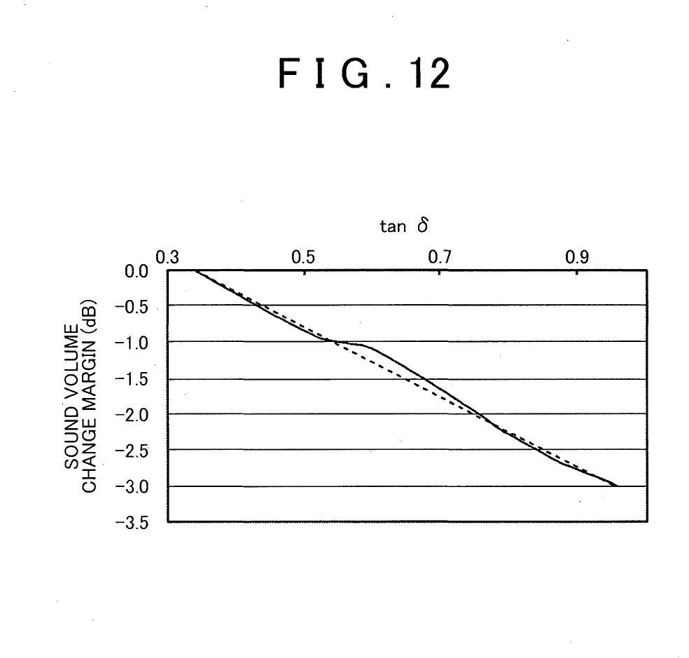

FIG. 12 is a graph illustrating a noise reduction effect of the connecting material. FIG. 12 is a CAE (Computer Aided Engineering) analysis result of a sound change margin (dB) for a vehicle model in which a connecting member is provided between a reinforcement and a roof. The vehicle model includes vehicle models of the roof panels according to Examples 1, 2.

A sound volume uses, as an index, a volume of a sound of 37 Hz in a front seat of the vehicle models. A continuous line indicates a relationship between a sound volume change margin and a loss factor in the computation model. A broken line indicates its regression line. FIG. 12 shows that the sound volume decreases monotonously as the loss factor increases.

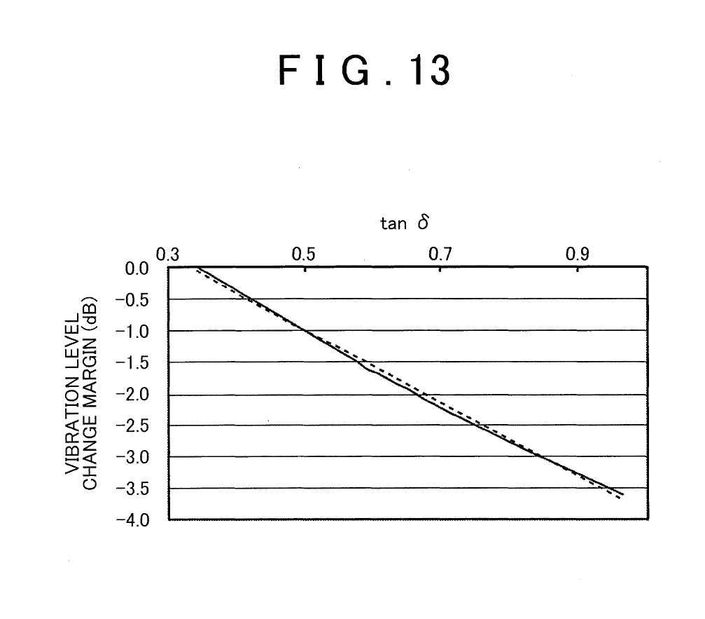

FIG. 13 is a graph illustrating a roof-panel vibration reduction effect of the connecting material. FIG. 13 is a CAE analysis result of a vibration level change margin (dB) for the same vehicle model. A vibration level uses, as an index, a vibration of 37 Hz in a part of the roof panel of the vehicle model which part vibrates strongly, namely, in a maximum amplitude part.

The maximum amplitude part corresponds to an antinode portion of vibration between the reinforcement installation regions. A continuous line indicates a relationship between a vibration level change margin and a loss factor in the computation model. A broken line indicates its regression line. FIG. 13 shows that the vibration level decreases monotonously as the loss factor increases.

The analysis results show that the sound volume decreases linearly when the vibration level decreases. Further, their change margins (dB) are in a relation of 1:1. For example, it is shown that a connecting material having a loss factor tan δ of 0.9 reduces the vibration level by around 3.5 dB and further reduces the sound volume by about 3 dB, in comparison with a connecting material having a loss factor tan δ of 0.35.

The analysis results show that the connecting material reduces noise generated in the vehicle panel structure, in Examples 1, 2. Further, the analysis results show that the vehicle panel structure provided with the connecting member has a noise reduction effect, in Examples 1, 2.

### [Reduction Effect of Material Used Amount]

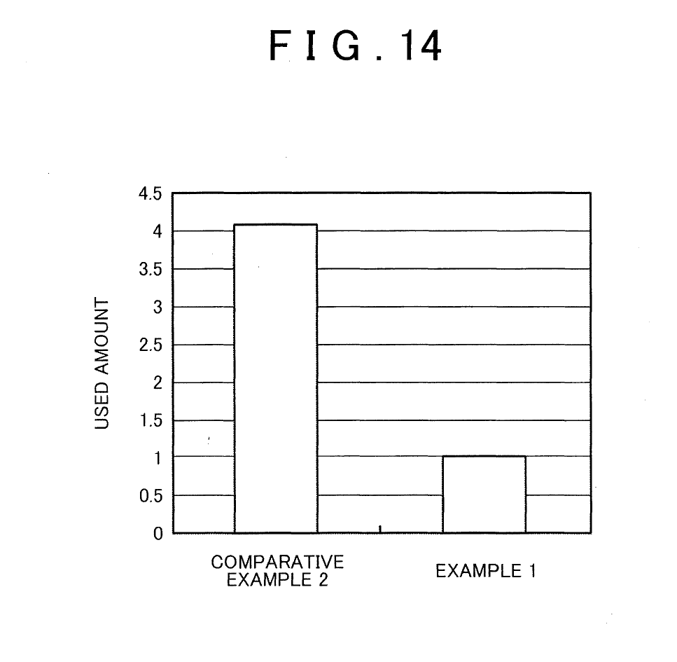

As described above, the connecting material 100 of Example 1 and the sheet material in Comparative Example 2 is the same butyl rubber. FIG. 14 illustrates a mass ratio of a used amount of the butyl rubber between Example 1 and Comparative Example 2. A used amount of butyl rubber of Example 1 is assumed 1. The used amount of butyl rubber in Example 1 decreases to about a quarter of that of Comparative Example 2.

FIG. 14 demonstrates that it is possible to decrease the used amount of butyl rubber by providing the connecting material 100 between the reinforcement 20 and the outer plate panel 40. Further, with the use of a connecting material having a high vibration damping efficiency, it is possible to decrease a used amount of a material having a vibration damping effect.

### Example 3

A vehicle panel structure of the present example is different from Comparative Examples 1 to 3 in the material of the connecting member 10, in the roof panel 93 illustrated in FIG. 3. A roof panel 93 herein includes a connecting member 10 made from a connecting material having a high loss factor as described in the embodiment and Examples 1, 2, instead of the mastic 99.

From other viewpoints, the roof panel 93 further includes a damp sheet 60, as well as constituents of the vehicle panel structures 90 of Examples 1, 2. The damp sheet 60 is made from a predetermined sheet material. A loss factor tan δ of the sheet material is not less than 0.25.

The roof panel 93 is able to further promptly reduce a vibration caused in its outer plate panel 40. Further, the roof panel 93 reduces noise caused due to the vibration of the outer plate panel 40, immediately.

An affix range 65 in a non-installation region 55 preferably occupies 50% or less of an area of the non-installation region 55, and further preferably 25% or less of the area of the non-installation region 55. The sheet material preferably has a loss factor tan δ of 0.6 or less.

A material of a constraint layer 66 is not limited in particular, but is preferably a glass fabric or a thin sheet of aluminum. The constraint layer 66 is connected to a damp sheet 60 to form a restriction-type vibration control structure. The constraint layer 66 that is sufficiently hard is able to give a desirable bending modulus of elasticity to the vibration control structure. Such a roof panel 93 has a high vibration control performance.

### Example 4

### Summary

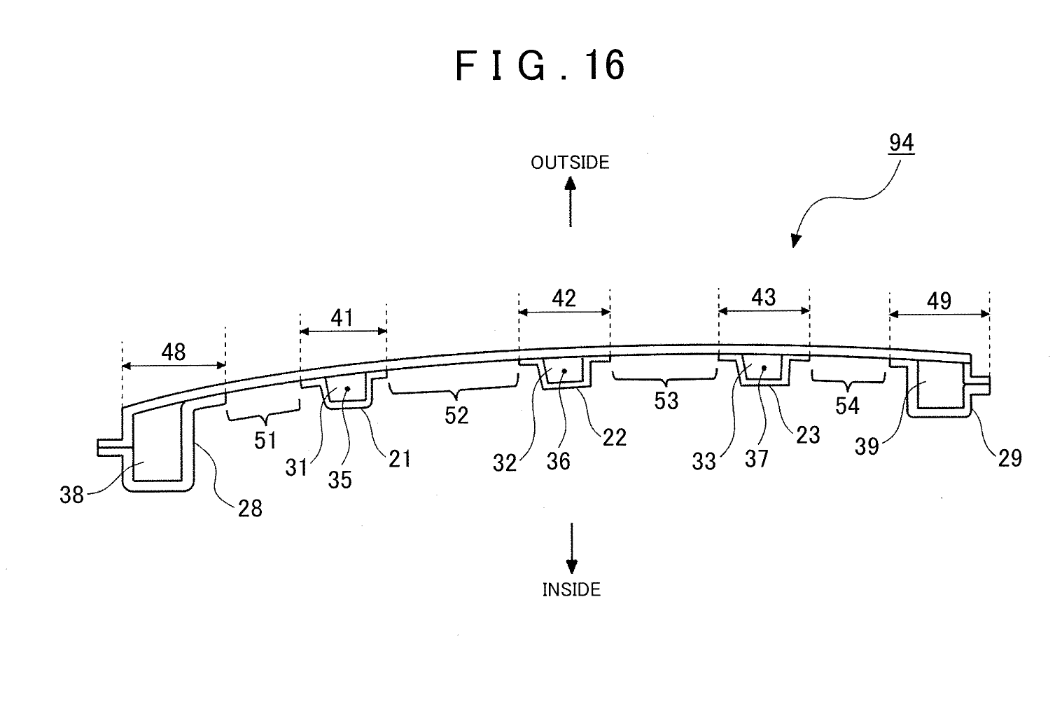

FIGS. 15, 16 illustrate a roof panel 94, which is one example of the vehicle panel structure 90. The roof panel 94 faces a side panel 58 on a vehicle left side and a side panel 59 of a vehicle right side. Reinforcements 21 to 23 illustrated in FIG. 16 are members equivalent to the aforementioned reinforcement 20.

A plurality of reinforcements 21 to 23 are arranged in line from a vehicular front side toward a vehicle rear side at given intervals. FIG. 16 illustrates three linear reinforcements 21 to 23. The shape and the number of reinforcements can be designed appropriately in consideration of a balance between a dent resistance characteristic and weight. The number of reinforcements may be one, two, or three, or four or more.

The reinforcement 21 is adjacent to a front header 28 on a vehicle front side and the reinforcement 22 on a vehicle rear side. The reinforcement 22 is adjacent to the reinforcement 21 on the vehicle front side and the reinforcement 23 on the vehicle rear side. The reinforcement 23 is adjacent to the reinforcement 22 on the vehicle front side and a rear header 29 on the vehicle rear side.

The reinforcements 21 to 23 arranged in such an order increase a rigidity of that central portion of an outer plate panel which cannot maintain the rigidity sufficiently only by the front header 28 and the rear header 29. Further, as described later, when the reinforcements 21 to 23 are connected to the outer plate panel 40 via connecting members each made from a connecting material having a high loss factor, a vibration control action is shown.

The reinforcements 21 to 23 have reinforcement skeletal centers 35 to 37, respectively. Installation regions 41 to 43 corresponding to the installation region 45 are placed along the skeletal centers 35 to 37, respectively, on a vehicle inner side.

### <Details>

As illustrated in FIG. 16, each of the reinforcements 21 to 23 has a recessed portion on its outer-plate-panel-40 side. The recessed portions of the reinforcements 21 to 23 have openings 31 to 33, respectively. The centers 35 to 37 are placed in the recessed′ portions of the reinforcements 21 to 23, respectively. That is, the respective recessed portions include the skeletal centers of the reinforcements, thereby giving flexural strength to the reinforcements 21 to 23.

The installation regions 41 to 43 are placed on that inner surface of the outer plate panel 40 which faces the vehicle inner side. The reinforcements 21 to 23 are opposed to the installation regions 41 to 43, respectively. The installation region 41 to 43 face the openings 31 to 33, respectively. The above structure increases a dent resistance characteristic of the roof panel 94. Even if a reinforcement has the same feature in the other examples or embodiments, the same effect is yielded.

Non-installation regions 51 to 54 are arranged alternately with an installation region 48 for the front header 28 on the vehicle front side, the installation regions 41 to 43, and an installation region 49 for the rear header 29 on the vehicle rear side.

The non-installation regions 51 to 54 are regions surrounded by the installation regions 41 to 43, the front and rear headers, an attachment part 56 to a side roof rail on the vehicle left side and an attachment part 57 to a side roof rail on the vehicle right side. The same applies to a case where the non-installation regions 51 to 54 are considered as a non-installation region as a whole. In terms of the “non-installation region as a whole,” see a modified example to be described later.

### <Aspect of Connection>

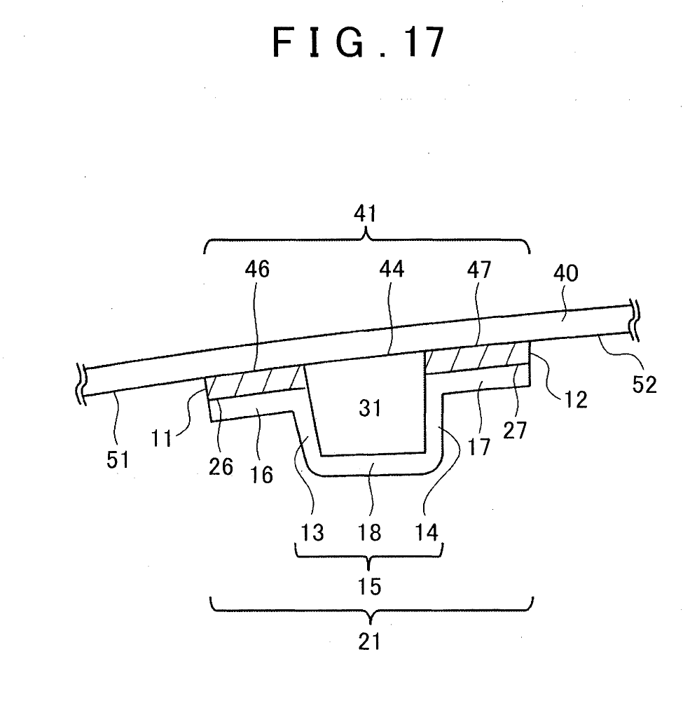

FIG. 17 is an enlarged view around a section of the reinforcement 21 in FIG. 16. As illustrated in FIG. 17, the reinforcement, 21 makes contact with a connecting member 11 via a connecting surface 26. The connecting member 11 is a member equivalent to the connecting member 10. The connecting surface 26 is placed in a flange 16 placed on an outer edge of the reinforcement 21 in a vehicle forward direction, and faces an outer-plate-panel-40 side.

The reinforcement 21 further makes contact with a connecting member 12 via a connecting surface 27. The connecting member 12 is a member equivalent to the connecting member 11. The reinforcement 21 includes a flange 17 placed on an outer edge in a vehicle rearward direction which outer edge is an opposite side to the flange 16 with the opening 31 therebetween. The connecting surface 27 is placed in the flange 17 of the reinforcement 21 and faces the outer-plate-panel-40 side.

The reinforcements 22, 23 have the same structure as the reinforcement 21. According to such a configuration, it is possible to manufacture the reinforcements 21 to 23 by plastically deforming one plate. Further, the reinforcements 21 to 23 become lightweight.

As illustrated in FIG. 17, a recessed portion 15 of the reinforcement 21 has a side wall 13, a side wall 14, and a bottom portion 18. In the figure, the recessed portion 15 has a box-like section, but may have an arc-like section.

The side wall 13 makes contact with the flange 16 and the bottom portion 18. The side wall 14 makes contact with the flange 17 and the bottom portion 18. The side wall 13 and the side wall 14 each form a predetermined angle with respect to the outer plate panel 40. This allows the reinforcement 21 to restrain deformation of the outer plate panel 40.

The reinforcement installation region 41 is placed between the reinforcement non-installation regions 51, 52. The installation region 41 has a reinforcement non-installation surface 44, a reinforcement installation surface 46, and a reinforcement installation surface 47. The installation surface 46 is opposed to the connecting surface 26 and makes contact with the connecting member 11. It is preferable that the connecting member 11 be placed only between the installation surface 46 and the connecting surface 26.

The installation surface 47 is placed on an opposite side to the installation surface 46 with the non-installation surface 44 sandwiched therebetween. The installation surface 47 is opposed to the connecting surface 27 and makes contact with the connecting member 12. It is preferable that the connecting member 12 be placed only between the installation surface 47 and the connecting surface 27. It is preferable that the non-installation surface 44 face a space forming the opening 31.

It is preferable for the opening 31 not to be filled with the connecting material 100 or the other fillers. If such filling is performed, an effect that the reinforcement 21 restricts the outer plate panel 40 becomes poor. Further, the outer plate panel may be deformed in the non-installation surface 44 in some cases.

Further, even if the opening 31 is filled with the connecting material 100, it is difficult to increase a vibration control effect, so that such filling is not advantageous in terms of a cost. Further, a noise reduction effect of the roof panel 94 of the present example relates to noise caused due to, a vibration of the outer plate panel 40, and is intended to reduce the noise by an action of damping the vibration.

Note that in a case where the filling is performed, no air passes through the reinforcement, which may make it difficult for sound to be transmitted. The present example does not exclude such a configuration and an action, but such an effect is subsidiary in the present example. In view of this, it is preferable that the opening 31 be an empty space. Similarly, it is preferable for the non-installation surface 44 not to make contact with the connecting material 100.

### <Headers>

The present example also shows a vehicle body of an automobile having a feature in a connection form of the front header 28 and the rear header 29 with respect to the outer plate panel 40. The vehicle body of the present example includes an outer plate panel 40 for the roof panel 94 having an installation region 48 or an installation region 49 on a front side or a rear side, on a vehicle inner side surface, as illustrated in FIG. 15.

The vehicle body further includes the front header 28 or the rear header 29 connected to the installation region 48 or the installation region 49. The vehicle body further includes a connecting member placed between the installation region 48 or 49 and the front header 28 or the rear header 29. It is preferable that a connecting member 10 be made, from a connecting material 100 having a loss factor tan δ of not less than 0.6.

As illustrated in FIG. 16, the front header 28 and the rear header 29 have respective recessed portions on their outer-plate-panel-40 sides. The respective recessed portions have an opening 38 and an opening 39. Centers of the front header 28 and the rear header 29 are placed in the respective recessed portions. That is, the respective recessed portions include skeletal centers of the headers, thereby giving rigidity to the front header 28 and the rear header 29.

The installation region 48 and the installation region 49 are placed on that inner surface of the outer plate panel 40 which faces a vehicle inner side. The front header 28 and the rear header 29 are opposed to the installation region 48 and the installation region 49, respectively. The installation region 48 and the installation region 49 face the opening 38 and the opening 39, respectively. The above structure increases a dent resistance characteristic of the roof panel 94.

The connecting member 10 (not shown) is placed between each of the installation region 48 and the installation region 49 and each of the front header 28 and the rear header 29, so as to make contact therewith. Accordingly, the roof panel 94 is able to promptly reduce a vibration caused in the outer plate panel 40. Further, the roof panel 94 immediately reduces sound caused due to the vibration of the outer plate panel 40. This allows the roof panel 94 to achieve noise reduction in vehicle inward and outward directions.

In the roof panel 94, the connecting member 10, the front header 28, and the rear header 29 constitute a restriction-type vibration control structure. Since the front header 28 and the rear header 29 efficiently function as a constraint layer, it is preferable that the front header 28 and the rear header 29 make contact with the connecting members 10.

Such a structure causes the following excellent effects. First, a vibration control performance of the roof panel 94 further increases. Further, the front header 28 and the rear header 29 make close contact with the outer plate panel 40, thereby restraining its deformation. That is, the front header 28 and the rear header 29 increases a dent resistance characteristic of the roof panel 94.

The connecting member 10 (not shown) is placed only between each of the installation region 48 and the installation region 49 and each of the front header 28 and the rear header 29. Such a structure is able to reduce an amount of the connecting material 100 without decreasing each of the above effects. This makes it possible to reduce an economical cost and an environment load for manufacture of the roof panel 94.

Note that, differently from the openings 31 to 33, the opening 38 and the opening 39 may be filled with various fillers. Even if such filling is performed, there is little possibility that the deformation of the outer plate panel 40 may occur.

### Example 5

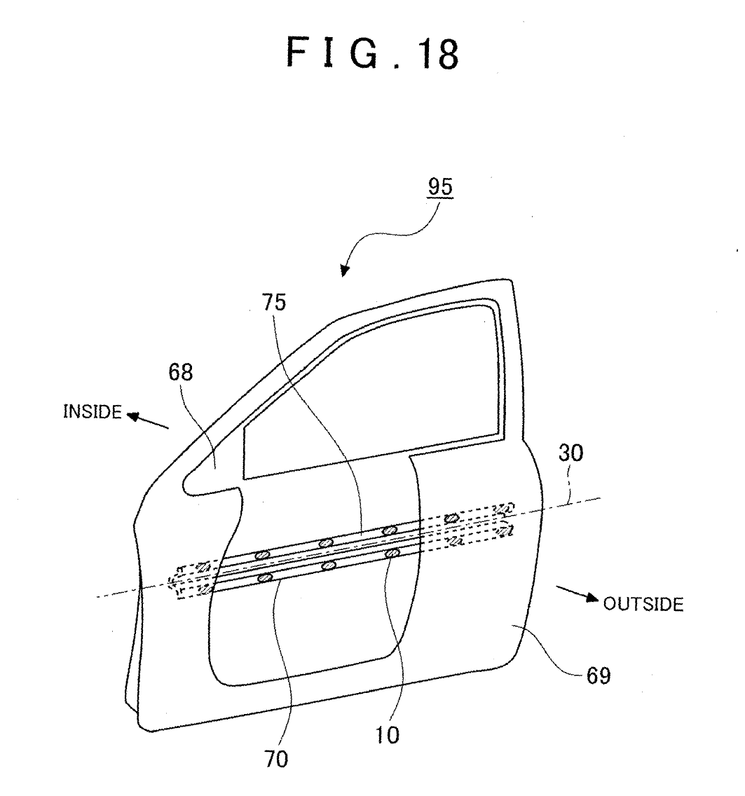

FIG. 18 illustrates a door panel 95, which is one example of the vehicle panel structure 90. The door panel 95 includes an inner plate panel 68 and an outer plate panel 69. As seen in a portion where the outer plate panel 69 is scooped out in FIG. 18, one or more reinforcements 70 are placed between the inner plate panel 68 and the outer plate panel 69.

It is preferable that the reinforcement 70 be attached to that part of the outer plate, panel 69 which is swollen toward a vehicle outside. This is because a restriction force from the inner plate panel 68 is hard to act on such a part and a vibration is easy to occur.

The reinforcement 70 makes contact with a vehicle inner side of the outer plate panel 69 with a connecting member 10 sandwiched therebetween. The reinforcement 70 may be attached in parallel to or at an angle of 0 to 45 degrees to a right-and-left direction of the door panel 92.

As illustrated in FIG. 18, it is preferable that the connecting member 10 form a continuous or discontinuous linear shape along a skeletal center 30 of the reinforcement 70. It is preferable that the connecting member 10 be placed in a range where the connecting member 10 does not protrude from a connecting surface 75 of the reinforcement 70. Further, the connecting member 10 may form a dispersed shape to be continued at predetermined intervals along the skeletal center 30 of the reinforcement 70.

In view of this, the door panel 95 is able to promptly reduce a vibration of the outer plate panel 69 during running or a vibration by an impact added to the outer plate panel 69 at the time when a door is closed vigorously. The door panel 95 is able to reduce noise from such a vibration, and particularly sound of door closing.

Such an aspect of the connecting member 10 is able to reduce a necessary amount of a connecting material 100 without decreasing its vibration control effect. This makes it possible to reduce an economical cost and an environment load for manufacture of the door panel 95. If the connecting member 10 has the same feature in the other examples or embodiments, the same effect is yielded.

The outer plate panel 69 can have a desired design. For example, the outer plate panel may have a press line having a folding portion of the outer plate panel. In such a case, the press line causes unevenness on a vehicle inner side surface of the outer plate panel 69. Such unevenness causes peeling or the like when the aforementioned damp sheet is affixed thereto.

However, the door panel 95 of the present example has a high vibration control effect even if the door panel 95 does not include the damp sheet. In view of this, the door panel 95 of the present embodiment is able to solve the problem with peeling or the like of the damp sheet, while having a high vibration control effect and a desired design. The press line can be provided on outer plate panels of the aforementioned roof panel and the other vehicle panel structures.

### Example 6

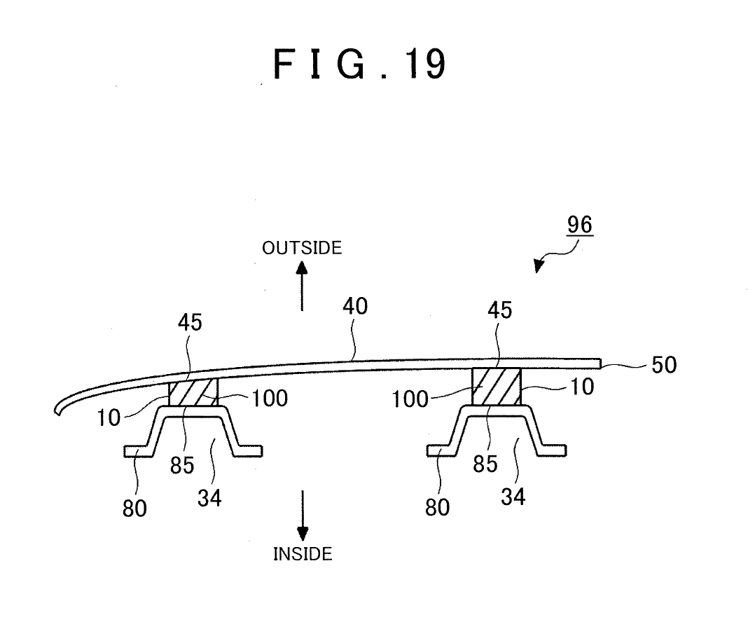

As illustrated in FIG. 19, a vehicle panel structure 96 of the present example includes a reinforcement 80. The reinforcement 80 makes contact with a connecting member 10 via a connecting surface 85. The connecting surface 85 is placed on a bottom portion of the reinforcement 80 and faces an outer-plate-panel-40 side. An opening 34 is placed on a flange side of the reinforcement 80 and faces an opposite side to the outer plate panel 40. A flange of the reinforcement 80 can be connected to an inner panel (not shown).

The vehicle panel structure 96 is able to promptly reduce a vibration caused in the outer plate panel 40. Further, the vehicle panel structure 96 immediately reduces sound caused due to the vibration of the outer, plate panel 40. This allows the vehicle panel structure 96 to achieve noise reduction in a direction of a vehicle inner side and a direction of a vehicle outer side.

### Example 7

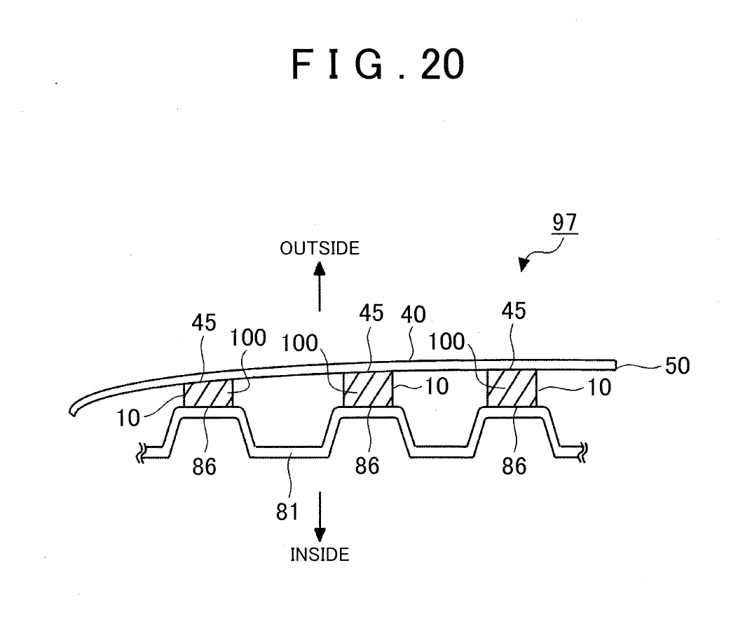

As illustrated in FIG. 20, a vehicle panel structure 97 of the present example includes a vehicle outer plate panel 40 having an installation region 45 for an inner plate panel 81, on an inner surface 50 on a vehicle inner side. The vehicle panel structure 97 further includes an inner plate panel 81 placed in the installation region 45.

The vehicle panel structure 97 further includes a connecting member 10 placed between the installation region 45 and the inner plate panel 81. It is preferable that the connecting member 10 be made from a connecting material 100 having a loss factor tan δ of not less than 0.6.

As illustrated in FIG. 20, the vehicle panel structure 97 of the present example includes the inner plate panel 81. The inner plate panel 81 makes contact with the connecting member 10 via a connecting surface 86. The connecting surface 86 is placed in the inner plate panel 81 in a vehicle outward direction and faces an outer-plate-panel-40 side.

The vehicle panel structure 97 is able to promptly reduce a vibration caused in the outer plate panel 40. Further, the vehicle panel structure 97 immediately reduces sound caused due to the vibration of the outer plate panel 40. This allows the vehicle panel structure 97 to achieve noise reduction in a vehicle inward direction and the vehicle outward direction.

In the vehicle panel structure 97, the connecting member 10 and the inner plate panel 81 constitutes a restriction-type vibration control structure. Since the inner plate panel 81 makes contact with the connecting member 10, the inner plate panel 81 functions as a constraint layer efficiently. The inner plate panel 81 may be formed by plastically deforming one plate, or may be formed by combining a plurality of members.

Such a structure causes the following excellent effects. First, a vibration control performance of the vehicle panel structure 97 further increases. Further, the inner plate panel 81 makes close contact with the outer plate panel 40 so as to restrain its deformation. The inner plate panel 81 has a sinuous section, so that the inner plate panel 81 increases a dent resistance characteristic of the vehicle panel structure 97, similarly to the reinforcement. That is, the inner plate panel 81 functions as a kind of the reinforcement 20 shown in the embodiment.

The connecting member 10 is placed only between the installation region 45 and the connecting surface 86. Such a structure is able to reduce an amount of the connecting material 100 without decreasing each of the above effects. This makes it possible to reduce an economical cost and an environment load for manufacture of the vehicle panel structure 97. The vehicle panel structure 97 of the present embodiment is suitable for a hood panel.

### Modified Example

Note that the present invention is not limited to the above embodiment and examples, and various modifications can be made within a range that does not deviate from a gist of the present invention. In the above embodiment and the like, the vehicle panel structure is described by taking, as an example, a passenger vehicle. Such a vehicle panel structure is preferably usable in a body outside plate of a bus, a truck, or a track transportation vehicle.

The above embodiment and the like mainly deal with the aspect of the connection between the reinforcement and the outer plate panel. However, the aspect of the connection is applicable to an aspect of connection between a header and the outer plate panel, and an aspect of connection between the inner plate panel and the outer plate panel, which will not be disturbed at all.

### <Non-Installation Region as a Whole in Example 4>

The vehicle panel structure in the embodiment and the like is able to yield a high vibration control effect even if all or some of damp sheets are omitted. Here, in Example 3, it is assumed that the damp sheet 60 having a predetermined size is affixed to the non-installation region 55. Such an aspect is also applicable to the other embodiments and examples.

For example, in Example 4, the reinforcement non-installation regions 51 to 54 are provided separately. In this case, the aspect of Example 3 may be applied to each of the non-installation regions 51 to 54. In the meantime, the non-installation regions 51 to 54 may be considered as a non-installation region as a whole and a ratio of an affix range of the damp sheet occupies the non-installation region may be designed.

For example, in FIGS. 15, 16, a damp sheet is not affixed to the non-installation region 51 (0%), and damp sheets may be affixed to the non-installation regions 52 to 54. In this case, the affix range of the damp sheets may occupy 25 to 50% of the non-installation region as a whole.

1. A vehicle panel structure comprising:
a vehicle outer plate panel having a reinforcement installation region on a vehicle inner side surface;
a reinforcement provided in the installation region; and
a connecting member placed between the installation region and the reinforcement, wherein:
the connecting member is made from a connecting material having a loss factor tan δ of not less than 0.6.

2. The vehicle panel structure according to claim 1, wherein:
the reinforcement makes contact with the connecting member.

3. The vehicle panel structure according to claim 2, wherein:
the reinforcement makes contact with the connecting member via a connecting surface placed in an outer edge of the reinforcement and facing an outer-plate-panel side.

4. The vehicle panel structure according to claim 3, wherein:
the connecting member is placed only between the installation region and the connecting surface.

5. The vehicle panel structure according to claim 4, wherein:
the connecting member forms a linear shape along a skeletal center of the reinforcement.

6. The vehicle panel structure according to claim 4, wherein:
the connecting member forms a dispersed shape continued at predetermined intervals along a skeletal center of the reinforcement.

7. The vehicle panel structure according to claim 1, wherein:
the reinforcement further includes a recessed portion placed in a skeletal center of the reinforcement and having an opening on the outer-plate-panel side, and
the installation region makes contact with the opening.

8. The vehicle panel structure according to claim 1, wherein:
the connecting member makes contact with the installation region.

9. The vehicle panel structure according to claim 1, wherein:
the connecting material has a loss factor tan δ of not less than 0.9.

10. The vehicle panel structure according to claim 1, wherein:
the connecting material is butyl rubber or rubber-modified asphalt.

11. The vehicle panel structure according to claim 1, further comprising:
a damp sheet made from a sheet material having a loss factor tan δ of not less than 0.25, wherein:
the outer plate panel has a reinforcement non-installation region on the vehicle inner side; and
the damp sheet is connected to the non-installation region.

12. The vehicle panel structure according to claim 11, wherein:
the damp sheet is connected to a predetermined range of the non-installation region, and the predetermined range occupies 25% or less of an area of the non-installation region.

13. The vehicle panel structure claim 11, wherein:
the sheet material has a loss factor tan δ of not more than 0.6.

14. The vehicle panel structure according to claim 1, wherein:
the outer plate panel has a reinforcement non-installation region on the vehicle inner side, and
the non-installation region is not connected to a damp sheet made from a sheet material having a loss factor tan δ of not less than 0.6.

15. The vehicle panel structure according to claim 14, wherein:
the non-installation region is not connected to a damp sheet made from a sheet material having a loss factor tan δ of not less than 0.25.

16. The vehicle panel structure according to claim 1, wherein:
the outer plate panel has a reinforcement non-installation region on the vehicle inner side;
a predetermined range in the non-installation region makes contact with a space on the vehicle inner side; and
the predetermined range occupies 75% or more of an area of the non-installation region.

17. The vehicle panel structure according to claim 1, wherein:
the outer plate panel has a reinforcement non-installation region on the vehicle inner side; and
the non-installation region makes contact with only a space on the vehicle inner side.

18. A roof panel having the vehicle panel structure according to claim 11, wherein:
a plurality of reinforcements is arranged in line at predetermined intervals; and
the non-installation region is surrounded by the installation region, front and rear headers, and installing parts to side roof rails.

19. A vehicle panel structure comprising:
a vehicle outer plate panel having an installation region for an inner plate panel on a vehicle inner side surface;
the inner plate panel provided in the installation region; and
a connecting member placed between the installation region and the inner plate panel, wherein
the connecting member is made from a connecting material having a loss factor tan δ of not less than 0.6.

20. A vehicle body comprising:
an outer plate panel for a roof panel, the outer plate panel having an installation region for a front or rear header on a vehicle inner side surface;
a header connected to the installation region;
a connecting member placed between the installation region and the header, wherein:
the connecting member is made from a connecting material having a loss factor tan δ of not less than 0.6.
